(19) United States
(12) Patent Application Publication
(10) Pub. No.: US 2010/0312390 A1
(43) Pub. Date: Dec. 9, 2010

(54) DOMESTIC ROBOT ASSISTANT HAVING A ROLLING CHASSIS

(75) Inventor: Vincent Dupourque, Anglet (FR)

Correspondence Address: YOUNG & THOMPSON, 209 Madison Street, Suite 500, Alexandria, VA, 22314, US

(73) Assignee: ROBOSOFT, Bidart (FR)

(21) Appl. No.: 12/600,093

(22) PCT Filed: May 14, 2008
(86) PCT No.: PCT/FR08/50833

§ 371 Date: Nov. 13, 2009

(30) Foreign Application Priority Data
May 14, 2007 (FR) 0755059

(51) Int. Cl. B25J 5/00

(52) U.S. Cl. 700/253; 901/1

(57) ABSTRACT

A robot includes a wheeled chassis (12), actuators that ensure the movement of the wheeled chassis (12), and command-control element to which sensors send information, characterized in that the wheeled chassis (12) includes two driving wheels (16) that have axes of rotation in a transverse plane and two wheeled elements (22) along at least two axes of rotation and/or pivoting that each have a vertical pivoting axis (24) that is arranged in the longitudinal median plane of the robot, and in that it includes a laser or radar that is arranged in a horizontal slot (38) that is made in the covering of the robot whose bottom has shapes that make it possible to optimize the field of vision of the laser.

This invention relates to a robot-type mobile platform that comprises a structure that imparts versatility thereto, more particularly suited for personal home assistance.

In the robotic world, numerous mobile robots have been developed in the fields of cleaning, monitoring, and entertainment, . . . However, the existing robots have all been developed so as to meet the constraints of their applications so that the robots of a field that is under consideration, for example the cleaning robots, are designed for their field and can be difficult to adapt to other fields. Furthermore, even if a robot of one field under consideration was modified to make it compatible with another field, its structure would not be suitable for this field, making the robot less capable.

Developing robots field by field leads to producing them as a unit or in very small series, which is reflected by relatively high manufacturing costs. This point constitutes an obstacle to the development of robots and greatly limits their spread.

In terms of design, the current robots are developed around their primary function. Thus, in the case of, for example, cleaning, the robot comprises a wheeled structure that integrates the tool or tools for cleaning.

So as to make it independent, the robot integrates a control that can monitor the movement of the structure and the operation of the tool or tools.

This control comprises programming that makes it possible to make the robot more or less independent, whereby the latter can react on its own to its environment, in particular to predictable events. Independence assumes that the programming calls for the onset of certain events, and then the suitable reaction or reactions to the latter.

As for the structure, even if there is a common origin, namely a system of use similar to that of a computer, ensuring the operation of memories and microprocessors, every robot designer develops a language that is unique to him to program the robot's different tasks or applications, in particular the applications that are relative to the movement. In contrast, the diversity of the types of programming languages also originates from the components that are used, such as the sensors, motors, etc., that have specific and non-homogeneous inputs and outputs from one component to another. These programming development costs that are specific to each application also lead to increasing the costs of the robots. Furthermore, these programming languages are so specific that they do no allow any independence to the user of the robot who cannot program it for optionally adding a new functionality.

Also, the purpose of this invention is to remedy the drawbacks of the prior art by proposing a structure of a mobile robot that is simple and polyvalent in design, to which modules based on tasks assigned to the robot can be easily adapted, whereby said structure imparts great handling to the robot.

For this purpose, the invention has as its object a robot that comprises a wheeled chassis, actuators that ensure the movement of the wheeled chassis, and command-control means to which sensors send information, characterized in that the wheeled chassis comprises two driving wheels that have axes of rotation in a transverse plane and two wheeled elements along at least two axes of rotation and/or pivoting that each have a vertical pivoting axis that is arranged in the longitudinal median plane of the robot and in that it comprises a laser or radar that is arranged in a horizontal slot that is made in the covering of the robot whose bottom has shapes that make it possible to optimize the field of vision of the laser. This arrangement makes it possible in particular for the robot to clear doorways and makes it possible to equip it with different accessories without this impairing its orientation.

Other characteristics and advantages will emerge from the following description of the invention, a description that is provided only by way of example, with regard to the accompanying drawings in which:

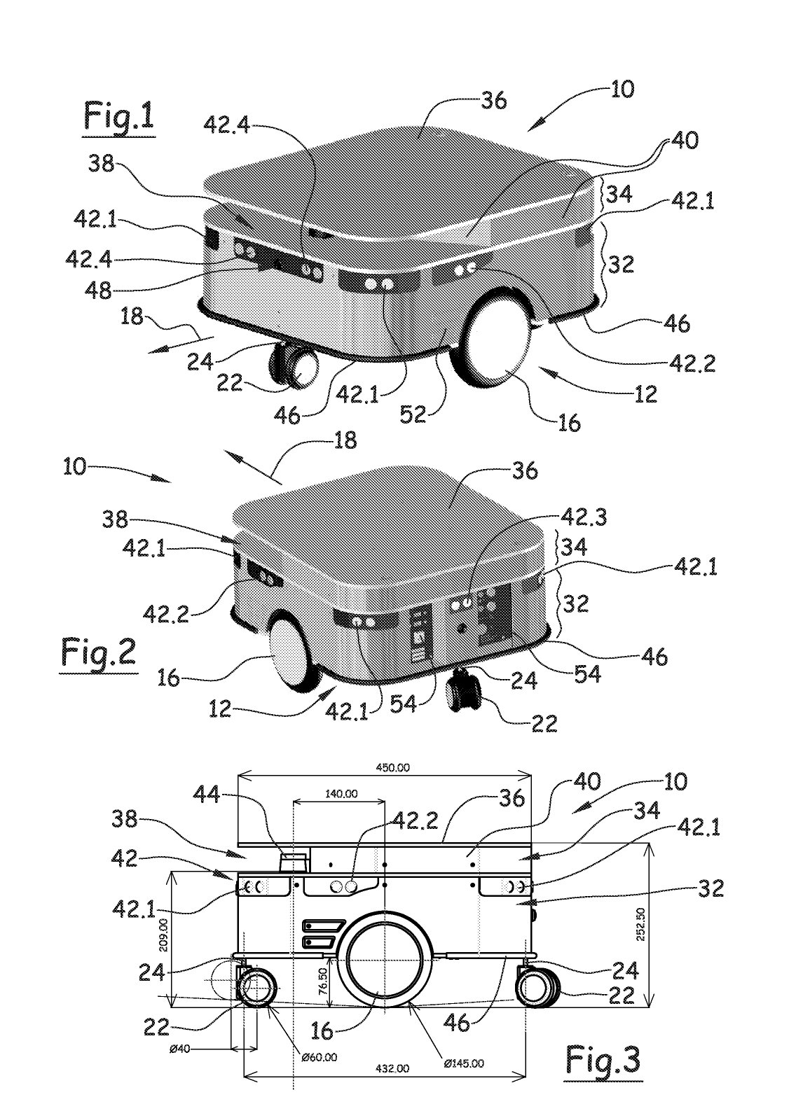

FIG. 1 is a perspective view that illustrates the front part of the robot according to the invention,

FIG. 2 is a perspective view that illustrates the rear part of the robot according to the invention,

FIG. 3 is a lateral view of the robot,

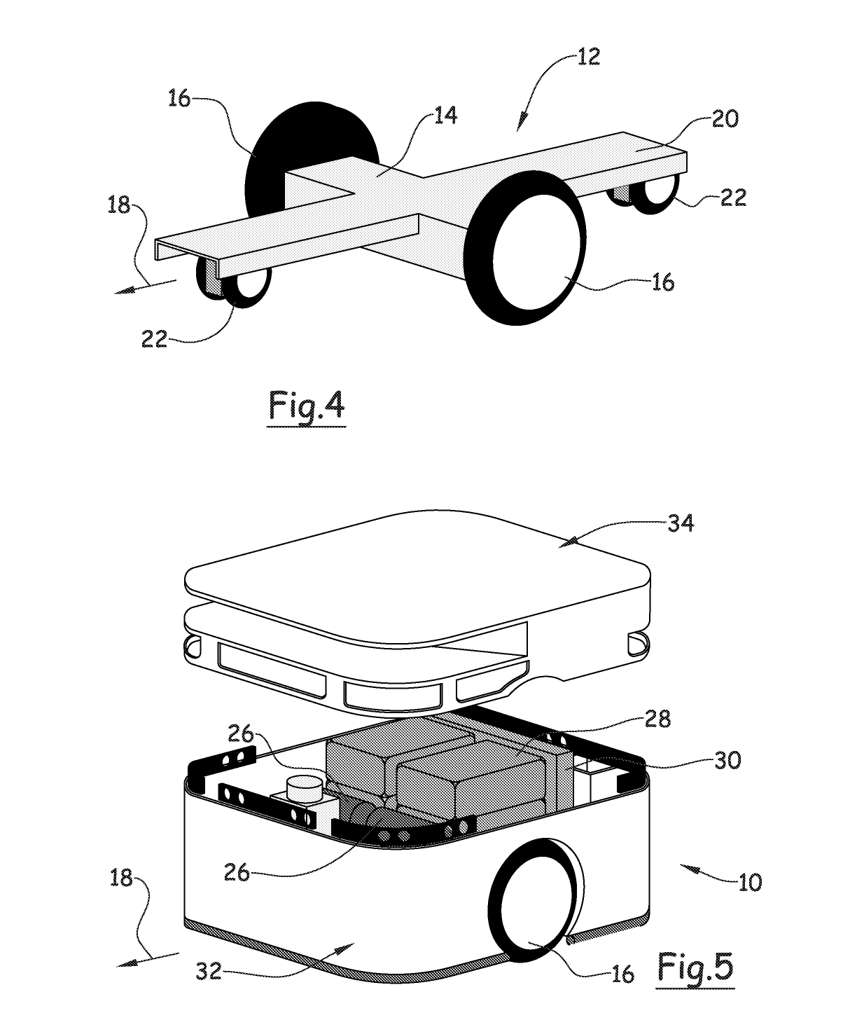

FIG. 4 is a perspective view that illustrates the wheeled chassis,

FIG. 5 is a perspective view that illustrates the inside of the robot, whereby the upper covering is raised,

FIG. 6 is a top view that shows the angle of release provided for the laser,

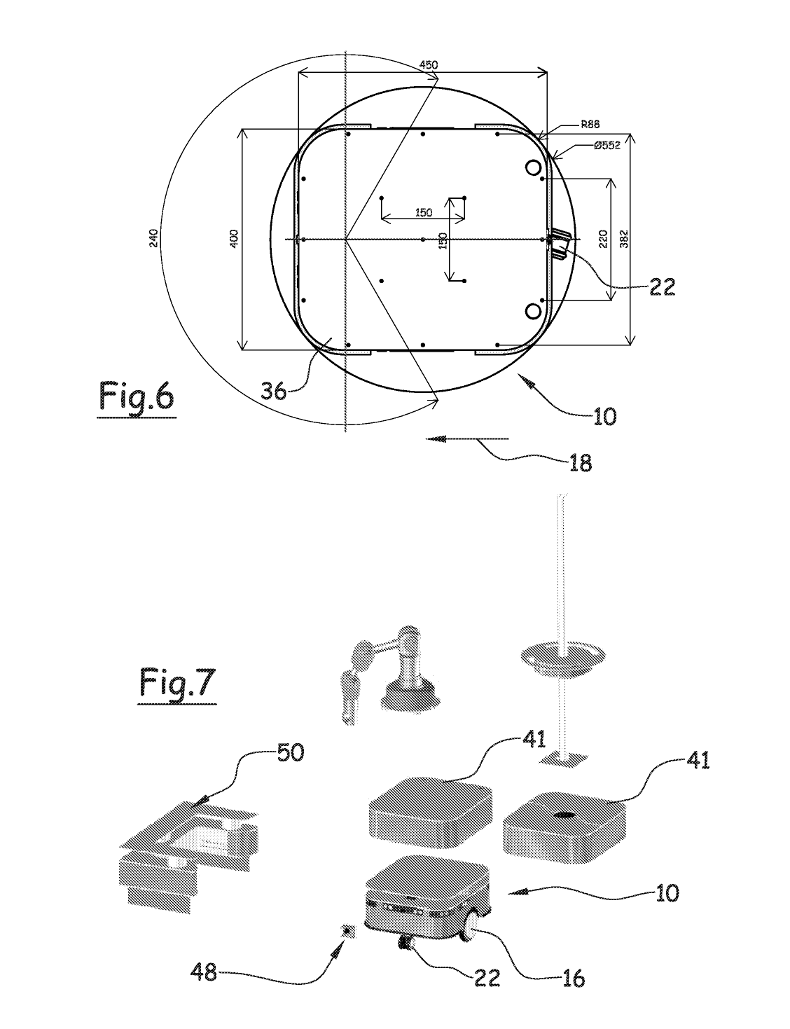

FIG. 7 is a perspective view that illustrates the accessories of the robot, in particular a receiving station for automatically recharging the power accumulation means, enhancements, a manipulating arm, and a mast that can carry a camera, and

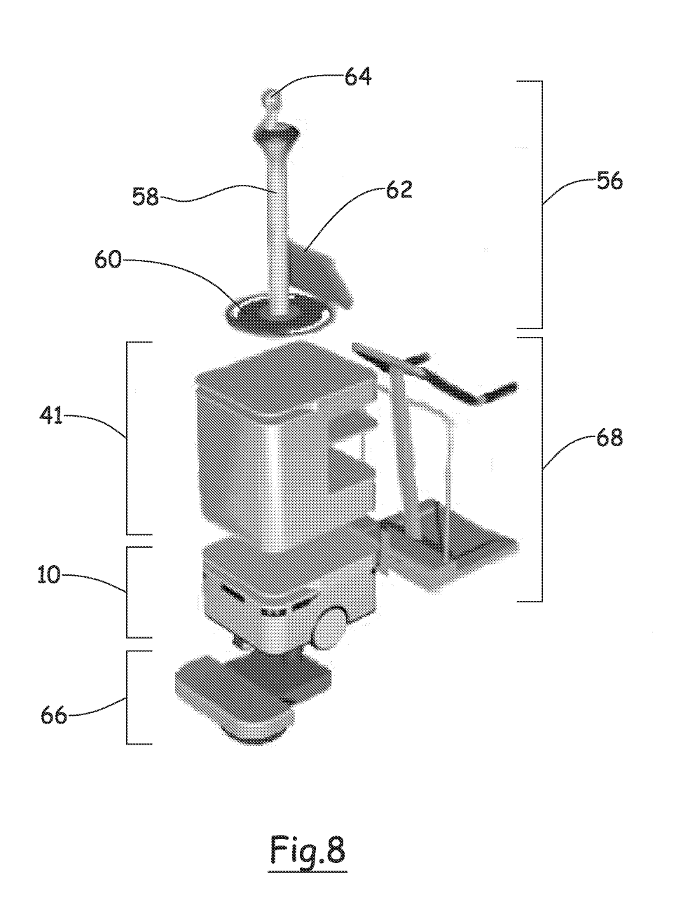

FIG. 8 is a perspective view of a robot according to the invention that is more particularly suited for personal home assistance.

In the various figures, a robot according to the invention is shown at 10, whereby the latter is more particularly suited for moving about in a domestic or industrial environment.

According to the invention, the robot forms a mobile platform on which different elements can be attached so as to configure the robot according to the task or tasks that are assigned thereto.

In its lower part, this robot comprises a wheeled chassis 12 that is illustrated in detail in FIG. 4.

This chassis 12 comprises a first beam 14 that is arranged in a transverse plane that at each of its ends supports a driving wheel 16 whose axis of rotation is essentially horizontal and arranged in a transverse plane. By way of indication, the wheelbase of the robot is on the order of 350 to 400 mm.

Hereinafter, transversal direction is defined as the direction that is perpendicular to the longitudinal direction (embodied by the arrow 18 in the figures), which corresponds to the front/rear movement of the robot.

In addition, the chassis 12 comprises a second beam 20, perpendicular to the first and forming a cross with the latter, to which idler wheels 22 are connected on both sides of the first beam 14.

Each idler wheel comprises a first horizontal axis of rotation that is connected to a yoke that is itself mounted to rotate around a pivoting axis 24 that is essentially vertical and that is connected to the second beam 20. Advantageously, the yoke of at least one of the idler wheels 22 can move translationally in a vertical manner along the pivoting axis on the order of about ten millimeters to make it possible for the robot to access slopes on the order of 6°.

For each idler wheel, return means, a spring for example, tend to constrain the idler wheel and more particularly the yoke in contact with the ground and to ensure the horizontal stability of the robot. The return force of the spring is suitable based on the mass of the robot to obtain a certain adhesive force at the driving wheels. Thus, the adhesive force at the driving wheels should not go below a predetermined threshold on the order of 100N.

By way of indication, the distance between the pivoting axes 24 is on the order of 430 mm.

As a variant, an idler wheel can be replaced by a wheeled element according to at least two axes of rotation and/or pivoting.

This configuration that uses wheels in the shape of a diamond makes it possible to obtain increased stability relative to a three-wheel configuration and great handling, whereby the robot can rotate on itself around a vertical axis that passes through its center.

According to the variants, the beams, in particular the second beam, can be made in several parts.

In any case, the driving wheels 16 have axes of rotation in a transverse plane whereas the idler wheels 22 have vertical pivoting axes that are arranged in the longitudinal median plane.

Thus, the chassis can be replaced by a carrying shell.

As illustrated in FIG. 5, the robot comprises, on the one hand, actuators that ensure the movement of the wheeled chassis, in particular two power plants 26, each one designed to drive in rotation, respectively, a driving wheel 16, power accumulation means 28, and, on the other hand, command-control means 30 that ensure the management of the different elements of the robot. According to one embodiment, the power plants 26 are of the electrical type, and the power accumulation means 28 are of the battery type.

Advantageously, the motors are dc motors without reduction gears, whereby the elimination of the reduction gear makes possible a saving in space and contributes to improving the mechanical reliability and the limitation of play.

Advantageously, the accumulation means 28 are arranged in the central part, the power plants 26 and the command-control means 30 distributed around so as to optimize the distribution of the masses and to place the center of gravity in the central position, the lowest possible to optimize stability.

All of these elements are protected by a body. The latter comprises a first covering 32 that forms a belt and a second covering 34 that forms a cover. According to the variants, the first and second coverings can be separate or made integral.

The first covering 32 has an essentially square or rectangular horizontal section with rounded angles. The wheels 16 are protected by the covering 32, whereby only the outside walls are visible and are flush with the outside surface of the covering 32.

By way of indication, the first covering has a width on the order of 400 mm, a length on the order of 460 mm, and a height on the order of 120 mm, and the first covering is inscribed in a diameter on the order of 550 mm. The ground clearance is on the order of 80 mm.

The second covering 34 comprises an upper board 36 whose perimeter is essentially identical to the section of the first covering 32, whereby said board is offset upward relative to the first covering 32 by a distance on the order of 40 mm to form a horizontal slot 38 whose function will be presented in detail below. A side wall 40 makes it possible to close the body between the first covering and the second covering and to delimit the bottom of the slot 38.

The upper board 36 comprises means for attaching accessories to the robot that are illustrated in FIG. 7, for example a camera in the case of a robot that is used for monitoring or a manipulating arm. As a variant, an enhancement 41 can be made integral to the upper board 36, whereby this enhancement delimits a cavity in which different accessories can be arranged, whereby said enhancement comprises—on the upper part —an essentially horizontal board that comprises connecting means analogous to those of the upper board 36 so as to attach accessories or another enhancement.

To send information to the command-control means 30, the robot comprises sensors. According to the invention, it comprises at least two sensor families, a belt 42 of ultrasound sensors as well as a laser or a radar 44.

The belt 42 comprises ultrasound sensors that are provided at the upper edge of the first covering 32.

The ultrasound sensors are preferred to ensure specific and reliable detection of objects at short range.

To ensure satisfactory detection, the belt 42 comprises ultrasound sensors 42.1 at angles of the first covering, an ultrasound sensor 42.2 at each lateral face of the robot, an ultrasound sensor 42.3 on the rear face, and two ultrasound sensors 42.4 arranged symmetrically on the front face of the robot.

Advantageously, the sensors 42.2 are offset toward the front relative to the axis of rotation of the driving wheels 16. This configuration makes it possible to help the robot detect which way is the front.

In any case, the sensors are flush with the body elements so as not to disturb the waves that are emitted or received.

The robot comprises a laser 44 that is arranged above the belt 42, in the slot 38 whose bottom that consists of the wall 40 comprises two sections that are oriented toward the rear and arranged symmetrically and forming an angle on the order of 240°. According to the invention, the latter 44 is protected by the second covering 34. This laser that can be replaced by a radar makes it possible to detect objects at longer range, but also to construct maps of the environment.

The release 38 makes it possible to optimize the laser's field of vision, whereby the latter is always protected by the upper covering. This detection of elements arranged toward the rear then makes it possible, when passing through a door, always to visualize the door frame and to continue to send information to the services that manage the robot's movements for a moment after said doorway is cleared.

In addition, this arrangement that has a radar in a slot makes it possible to bring the radar closer to the intersection of diagonal lines of the diamond formed by the wheels so as to optimize the passage through a door and to add different accessories to the robot without interfering with the orientation of said robot.

In addition to the belt 42 of ultrasound sensors and laser 44, the robot comprises an odometric system that makes it possible to measure the movements of the robot.

In addition, in the lower part of the first covering 32, the robot can comprise impact sensors, for example, sensitive bumpers 46, and/or at least one video sensor 48 or a camera (visible in FIG. 7). The sensor 48 advantageously supplements odometry, the ultrasound sensors and laser or radar, in obstacle detection functions, location of the robot in its environment, or 2D- and 3D-reconstruction of its environment.

In FIG. 7, a receiving station 50 that is used in particular for recharging the batteries 28 is shown. For this purpose, at least one of the lateral faces of the robot comprises connection means 52 for ensuring the power transfer. As illustrated in FIG. 2, the rear face comprises at least one housing 54, preferably two, in which are placed plugs, lights and/or means of control or adjustment.

Advantageously, the command-control means 30 comprise means for communication with other robots, computers or terminals such as a mobile phone or a personal [digital] assistant [PDA], for example, whereby the transmission can be performed by a wire-type connection or by electromagnetic waves that use different communication protocols, and even by the Internet.

FIG. 8 shows a variant of a robot according to the invention that is more particularly suited for personal home assistance.

Thus, robot 10 comprises an enhancement 41 that is used in particular for containing equipment or accessories of the robot (for example, additional batteries) or personal effects.

The robot can also support means for display and communication 56 comprising a mast 58 that is mounted to pivot relative to the enhancement or to the covering of the robot and that supports a board 60 to which at least one element such as a screen 62, a computer, a mobile phone, or a PDA can be connected for making it possible in particular for an individual seated close to the robot to communicate.

At the upper part of the mast 58, a camera 64 is provided for displaying the environment of the robot. This camera is preferably arranged at an individual's eye level. The mast can optionally support several cameras that are arranged at different heights.

Advantageously, the robot can be equipped with other accessories, in particular at the lower part of a cleaning device 66, and/or a device 68 can be towed to make it easier to move about or to change posture (seated/standing/seated). Finally, set accessories for the robot can be provided, such as, for example, a collecting station that is used in particular for recharging batteries.

1. Robot that can be used for personal home assistance, comprising a wheeled chassis (12), actuators (26) that ensure the movement of the wheeled chassis (12), and command-control means (30) to which sensors send information, characterized in that the wheeled chassis (12) comprises two driving wheels (16) that have axes of rotation in a transverse plane and two wheeled elements (22) along at least two axes of rotation and/or pivoting that each have a vertical pivoting axis (24) that is arranged in the longitudinal median plane of the robot, and in that it comprises a laser or radar (44) that is arranged in a horizontal slot (38) that is made in the covering of the robot whose bottom has shapes that make it possible to optimize the field of vision of the laser or radar.

2. Robot according to claim 1, wherein the bottom of the horizontal slot (38) comprises two sections that are arranged symmetrically and that form an angle on the order of 240°.

3. Robot according to claim 1, wherein it comprises an ultrasound sensor barrier (42).

4. Robot according to claim 3, wherein it comprises a covering that has an essentially square or rectangular horizontal section with rounded angles, and wherein the ultrasound sensor belt comprises ultrasound sensors (42.1) at the covering angles, an ultrasound sensor (42.2) at each lateral face of the robot, an ultrasound sensor (42.3) on the rear face, and two ultrasound sensors (42.4) that are arranged symmetrically on the front face of the robot.

5. Robot according to claim 1, wherein at least one of the wheeled elements (22) along at least two axes of rotation and/or pivoting can move translationally along its pivoting axis (24) to allow the robot access to inclined planes.

6. Robot according to claim 5, wherein return means are provided to keep the wheeled element (22) in contact with the ground along at least two axes of rotation and/or pivoting.

7. Robot according to claim 6, wherein the return means exert a force that makes it possible to obtain—at the driving wheels (16)—an adhesion to the ground that does not go below a determined threshold.

8. Robot according to claim 1, wherein it comprises a covering with an upper board (36) that is essentially horizontal and that comprises means for attaching accessories.

9. Robot according to claim 2, wherein it comprises an ultrasound sensor barrier (42).

10. Robot according to claim 2, wherein at least one of the wheeled elements (22) along at least two axes of rotation and/or pivoting can move translationally along its pivoting axis (24) to allow the robot access to inclined planes.

11. Robot according to claim 3, wherein at least one of the wheeled elements (22) along at least two axes of rotation and/or pivoting can move translationally along its pivoting axis (24) to allow the robot access to inclined planes.

12. Robot according to claim 4, wherein at least one of the wheeled elements (22) along at least two axes of rotation and/or pivoting can move translationally along its pivoting axis (24) to allow the robot access to inclined planes.

13. Robot according to claim 2, wherein it comprises a covering with an upper board (36) that is essentially horizontal and that comprises means for attaching accessories.

14. Robot according to claim 3, wherein it comprises a covering with an upper board (36) that is essentially horizontal and that comprises means for attaching accessories.

15. Robot according to claim 4, wherein it comprises a covering with an upper board (36) that is essentially horizontal and that comprises means for attaching accessories.

16. Robot according to claim 5, wherein it comprises a covering with an upper board (36) that is essentially horizontal and that comprises means for attaching accessories.

17. Robot according to claim 6, wherein it comprises a covering with an upper board (36) that is essentially horizontal and that comprises means for attaching accessories.

18. Robot according to claim 7, wherein it comprises a covering with an upper board (36) that is essentially horizontal and that comprises means for attaching accessories.

19. Robot according to claim 10, wherein it comprises a covering with an upper board (36) that is essentially horizontal and that comprises means for attaching accessories.

20. Robot according to claim 11, wherein it comprises a covering with an upper board (36) that is essentially horizontal and that comprises means for attaching accessories.
